(19) United States
(12) Patent Application Publication
(10) Pub. No.: US 2006/0188119 A1
(43) Pub. Date: Aug. 24, 2006

(54) System and method for rapidly supplying custom hearing devices

(76) Inventor: William S. Parker, Ann Arbor, MI (US)

Correspondence Address: Clifford Kraft;Suite 274, 27 N. Wacker Dr., Chicago, IL, 60606, US

(21) Appl. No.: 11/361,752

(22) Filed: Feb. 23, 2006

Related U.S. Application Data
(60) Provisional application No. 60/655,848, filed on Feb. 24, 2005.

(51) Int. Cl. H04R 25/00

(52) U.S. Cl. 381/322

(57) ABSTRACT

A method and system for conveniently producing a hearing device for a consumer that can involve manufacture of a hearing aid or other hearing device from a mobile site or a site the is near and convenient for the consumer. Techniques similar to those used in dentistry can be used to take impressions of the ear canal, produce a mold, and finally produce a custom fitted hearing device. Alternatively, a light curable resin can be placed into the outer ear canal and partially or totally hardened with a light source in-situ to take the shape of the ear canal. The device can be removed and finished. Hearing aid electronics can be mounted into cavities created in the device to form a final hearing aid or other hearing device. By supplying hearing aids or other devices on-site, the consumer pays less, and can receive a final fitted hearing device in around an hour.

This application is related to and claims priority from U.S. Provisional Patent Application No. 60/655,848 filed Feb. 24, 2005. Application 60/655,848 is hereby incorporated by reference.

### BACKGROUND

1. Field of the Invention

The present invention relates generally to the field of hearing devices and more particularly to a system and method for supplying custom hearing aids and other hearing devices to consumers.

2. Description of the Prior Art

Hearing aids or other ear-fitting hearing devices are required by significant numbers of people—perhaps a much as 10% of the population need or will need hearing assistance of some sort, usually in the form of a hearing aid device. The best-performing, best appearing, and most comfortable hearing aids are those that are custom fitted to the ear. This class of device allows the hearing aid to be unobtrusive in appearance and to optimally utilize the sound gathering structure of an individual's outer ear. However, only about 1 in 5 people with hearing loss actually purchase hearing aids in the U.S. Generally this is because of the cost and inconvenience of the device and the genuine hardship in purchasing one. In 2004, around 2 million hearing aids were sold in the U.S. through around 10,000 dispensing locations. The average retail price was about $2000. Industry revenues were around 4 billion dollars. The 10,000 fixed retail locations that offer hearing aids are a small and inefficient form of distribution. The median sales number is less than 20 hearing aids per month per location, or about 200 per year. Profitability is low for the retailer because of the inefficiency and the control that the large hearing aid manufacturers have over gross margins.

Custom fitted hearing aids have generally required custom fitting in at least two appointments, and many times more. The first appointment usually results in an impression of the ear canal and an assessment of the patient's hearing. The impression is sent off to a lab where a custom hearing device is made. The second visit is to pick up and double check the fitting of the device. Many times, the fitting needs to be adjusted. This requires the device to be returned to the lab with a third appointment scheduled. Such a series of appointments are often a hardship on the patient requiring travel to a sales location several times. This can be particularly difficult for elderly or infirm patients. Also, such custom-fitted devices are very expensive because of the cost of large scale manufacturing facilities, the communication requirement associated with such distant manufacturing locations, and the cost of multiple visits.

In addition to people with actual hearing difficulties, large number of work environments require workers to wear ear protection devices. Custom fitting devices are known to be more efficient and comfortable than simple ear plugs, especially if the device must be worn for prolonged periods. Custom fitted ear protection devices however may require workers to make multiple trips away from the work site in order to fit and procure the device. Also, earphones and other sound listening or environmental quieting devices work better and are much more efficient if they are custom fitted.

Hessel and Widmer in U.S. Pat. No. 6,731,997 present a method for manufacturing hearing devices that were based on an individual's particular hearing needs and an individual's physical outer ear structure using computerized 3-dimensional CAD/CAM techniques. While the Hessel/Widmer technique results in a fairly high-quality hearing device, it does not address or solve the problems of multiple visits or high costs. In fact, it probably increases costs because of the technology intensive computer power and communication required. Also, Hassel/Widmer do not solve the problem of bringing a facility to the consumer's location or of reducing the scale of manufacturing to provide a hearing device. U.S. Pat. No. 6,731,997 is hereby incorporated by reference.

It is known in the dental arts to provide materials that are ideal for taking impressions of parts of the mouth. It is also known to provide other dental or dental-like materials that can be molded, cast, or formed and hardened into various shapes with almost any color. These materials are very compatible with human contact and produce low levels of allergic reaction. Such materials are manufactured and packaged for very small scale, convenient use. Dental labs regularly supply bridges, crowns, dentures and other dental fixtures that are custom made to fit a particular person. Such materials and techniques could also be used to create custom hearing devices. These materials meet FDA standards and are manufactured in facilities that meet the Good Manufacturing Practices (GMP) guidelines of the FDA.

It is also known in the consumer servicing arts to provide service direct to a customer at their location. Examples are windshield replacement in a driveway or in an office parking lot; steamer trucks that bring an industrial steamer and vacuum to a home for rug cleaning; mobile dental and medical offices; mobile locksmiths and many others. It is also known to provide quick turn-around on items that previously required sending off to a lab (for example Lens Crafters for eyeglasses).

It would be advantageous to have a system and method for directly delivering to the end user a hearing aid device in a single visit, or better yet, at the user's location (for example, a nursing home or manufacturing facility). This system and method should be able to assess the patient's hearing needs, make the necessary measurements of the ear, produce the device and make adjustments to the device to suit the needs of the patient at one place within not more than several hours. This can be possible through the use of materials and techniques similar to those used by dental labs. Also, because of the speed and convenience, the final cost of the device should be significantly less to the patient.

### SUMMARY OF THE INVENTION

The present invention relates to a system and method for efficiently supplying an ear-fitting hearing device at a particular location, such as a mobile van, where a consumer can obtain a custom hearing device in a single visit where during the visit, the following steps can be performed: optionally giving the consumer a hearing test to determine specifications for a hearing aid; taking a mechanical impression of the consumer's ear; making a mold of the impression that is normally of translucent material; producing a rigid hearing device from the mold by injecting a fast curing resin, preferably a light-cured resin; de-burring and polishing the resin device; and fitting said rigid hearing device to the consumer. In general, techniques and materials known in the dental arts can be advantageously used. When a hearing test is given, the system can provide an electronic hearing aid component that can be mounted in the final device that is adjusted to requirements of the hearing test.

A preferable method is to make the rigid hearing device from a light-curable resin and to cure it in a chamber with either visible or ultraviolet light. Either the final electronics or an insert can be put into the resin before it cures. In the case of an insert, a cavity is normally made in the device that will receive the electronics. A second preferable method is to form the shell of the entire hearing device or hearing aid in-situ inside the patients ear or ear canal.

It is an object of the present invention to provide a self-contained and mobile facility or vehicle for the complete manufacturing of an in-the-ear hearing device.

It is a further object of the invention to, within the self-contained manufacturing facility or near it, provide a hearing test in order to produce a custom device matching the person's hearing needs.

It is a further object of the invention to produce a finished device in a single visit in about an hour.

It is a further object of the invention to incorporate pre-engineered and pre-packaged sets of electronics and components for different price ranges according to the patient's needs. The preferred pre-packaged set of electronics is generally known as a pre-wired faceplate.

It is a further object of the invention to use dental techniques and dental type materials to produce castings and/or moldings in a simple mechanical way which replicate rapidly the anatomical shapes of a patient's ear canal.

It is a further object of the invention to provide a mobile manufacturing facility to be positioned near the patient for single visit delivery of custom hearing devices.

It is still a further object of the present invention to allow formation of the shell of a hearing device within a patient's ear or ear canal.

### DESCRIPTION OF THE FIGURES

The following figures illustrate various aspects of the present invention:

FIGS. 1A-1B show a van that can be used as a mobile hearing device manufacturing laboratory.

FIG. 2 is a flow-chart of the steps necessary to produce a custom hearing device in one embodiment of the invention.

FIG. 3 is a sectional view diagram of a the anatomy of a human outer ear.

FIG. 4 shows formation of a hearing device shell within a patient's ear using an external light source.

FIG. 5 shows formation of a hearing device shell within a patient's ear or ear canal using a light pipe.

FIG. 6 shows a flow chart similar to that of FIG. 2 for an embodiment where curing takes place in-situ in the patient's ear.

Several illustrations and figures have been presented to better aid in the understanding of the present invention. The scope of the present invention is not limited to the figures.

### DETAILED DESCRIPTION OF THE INVENTION

The present invention relates to a system and method for supplying custom hearing devices to consumers at a single location in a single visit, preferably at the consumer's location at a reasonable cost. A single visit means that the person does not have to return on a different day to receive the finished device and be fitted, but rather that the person can receive the device within the time span of an hour or several hours. During the hour(s) of waiting on this single visit, the person can leave the facility and come back a little later. In one embodiment of the present invention, an entire hearing device manufacturing facility could be contained in a van that could visit the locations (such as a nursing home, shopping mall, manufacturing plant parking lot, etc.), so those who need hearing devices would not have to travel.

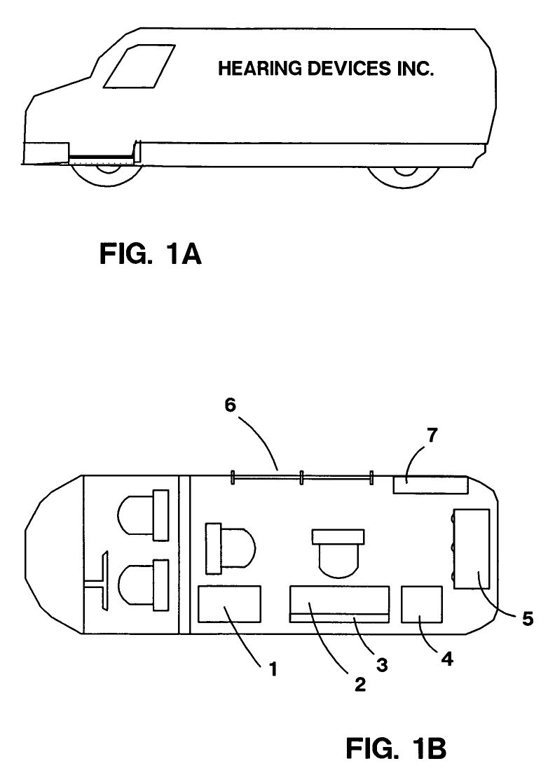

A complete mobile facility such as that shown in FIGS. 1A-1B can be contained in a van. A person needing a hearing device can visit the van, where a part may be set aside for patient evaluation. The person's hearing can be checked by a standard computerized hearing test device (with the test supervised by an audiologist if required), or the audiologist could actually run the test in a typical location where the device might be used such as inside the person's home or in a plant environment. An impression of the person's ear can be taken using a technique similar to the dental techniques used for getting tooth or mouth impressions. The impression can immediately and quickly be used to create a model from which the final device form can be made. Simple machining on the molded form can produce the necessary cavities and orifices for the hearing aid electronics, microphone, earphone, etc. The electronic parts are available and known in the art. They can be custom set or programmed to match the person's hearing needs (frequency equalization for example). A final hearing device can be ready for fitting within an hour or two. The patient would then be fit, and any necessary mechanical changes or adjustments can be very quickly made.

The van or mobile lab in FIG. 1B, in addition to containing an area for patient reception and hearing testing 1, can contain a small manufacturing space complete with all the equipment needed to make a complete hearing device from the hearing requirement's specification and an impression of the patient's ear. This area of the van can contain molding, casting, and miniature machining equipment to produce the finished product. For example, the van can contain a workbench 2 shelves 3, a curing chamber 4, supply cabinets 5 and other areas and/or equipment. An test bench 7 could be used to test the final device to make sure it meets the specifications required by the hearing test. The van could have side doors 6 or rear doors, and could be any type of vehicle from the small van shown in FIG. 1A to a large trailer. Optionally, the entire operation does not have to be mobile, but rather could be carried out at an office, store, professional building, or any other location.

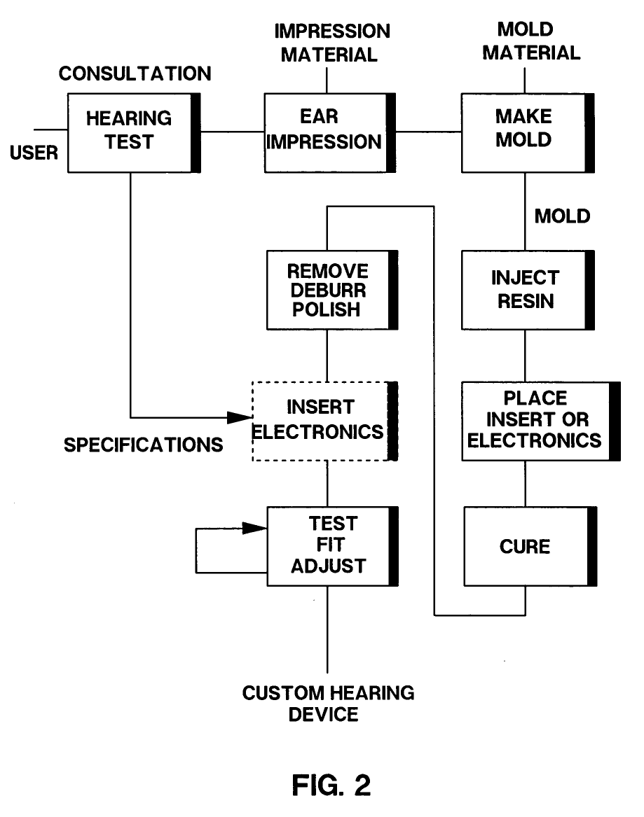

Turning to FIG. 2, a flow-chart of the preferred embodiment of the present invention is seen. This chart presents the major steps that can be used in a mobile or mini-lab to quickly produce a custom hearing device in a short period of time. The process normally begins as previously discussed with a patient evaluation and a hearing test if a hearing aid is needed. Each human ear has a frequency response curve that is a function of frequency. People with hearing defects typically have frequency response curves that have a lower total response and that roll off early at the high frequency end. One goal of the hearing device is to adjust the person's actual hearing curve to look as much like the normal response curve as possible without introducing extra peaks and valleys in the final curve. The final hearing aid electronics may be adjusted for equalization depending on the cost and sophistication of the electronics. Some hearing aid electronics are standard and non-adjustable, while other, more expensive units have as many as 7-8 equalization bands.

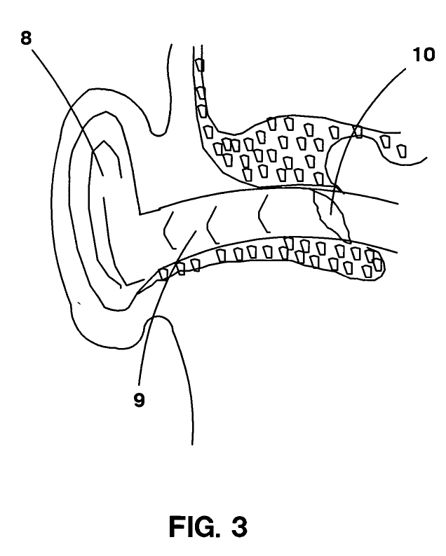

A sample of 2-part impression material can be mixed automatically in its applicator syringe (or otherwise) and applied into the ear canal to produce a rubbery impression of the ear canal. This material is a normally rubbery polymer known in the art that sets up in a few minutes. This impression forms a mechanical memory or impression of the ear canal anatomy. Preferred impression materials include polyvinyl siloxanes (PVC) which are supplied in two parts that polymerize within a short period of time after being mixed. There are numerous brands of such materials on the market and known in the dental and other arts. FIG. 3 shows a sectional view of the anatomy of the human outer ear. It can be seen that the earlobe or pinna 10 funnels into the external ear canal or auditory meatus 11 that terminates at the ear drum or tympanic membrane 12. The material used to take the impression must not produce too much heat or have other undesirable properties, and generally it must not run or flow into contact with the ear drum 12.

Returning to FIG. 2, the resulting ear canal impression can be removed from the ear and may be trimmed with scissors or a sharp blade to a desired overall length for mold production. The trimmed impression can be surrounded with a quick-setting light-transmitting mold material. This material is generally translucent so that light can be transmitted through it to its inner cavity. When the mold has set (usually several minutes), the impression can be extracted from the mold due to its flexible and elastic nature. The impression is preserved at this point. The preferred mold material is generally an acrylic that can be heat-activated to produce a translucent mold in about 30 minutes. Numerous brands of such mold materials are on the market and are known in the dental and other arts.

In the preferred embodiment, a visible light cured (VLC) or ultraviolet light cured (UVLC) resin is then injected into the empty cavity of the translucent mold. The final color of the resin can be chosen to match the color of the patient's skin. The mold containing the light cured resin is generally placed in a curing chamber for several minutes where it is exposed to the correct light at the proper intensity. The resin cures and becomes hard. Any material that can be made into a hearing aid shell is within the scope of the present invention as is any method of forming the material including casting or machining. Particular types of preferred resin materials are Diamond Link™, Diamond Flow™ and Diamond Crown™ materials sold by DRM Research Laboratories of Branford, Conn.

In one embodiment of the present invention, a removable insert may be inserted into the uncured resin prior to VLC or UVLC curing to produce an internal cavity in the resin shell for later installation of the electronics (for the case of a hearing aid). In another embodiment, the internal cavity can be cut with a miniature machine tool later, and in still another embodiment, a complete hearing aid assembly or plug can be inserted into the uncured resin prior to curing. Any method for producing a cavity within the shell to hold components is within the scope of the present invention.

After the resin has cured, it can be removed from the mold, and polished and de-burred with a small hand or machine tool. Such tools are known in the dental arts for grinding or polishing and can be designed and specified to be compatible with the particular resins used. In an embodiment of the present invention where the electronics were inserted before curing, all that remains is testing and fitting. In embodiments where a plug or inserts are used, they must be removed and the electronics installed.

Once the electronic parts are installed and the device is polished, the electronics can be tested using a standard test bench to make sure the final device matches the required audio characteristics required by the hearing test or audiologist report. The patient can then be fitted with the device, and any necessary mechanical adjustments can be made usually be minor grinding and polishing with a small tool. The patient can be given instructions and supplied with a custom hearing device within an hour, or at most several hours from the start of the process.

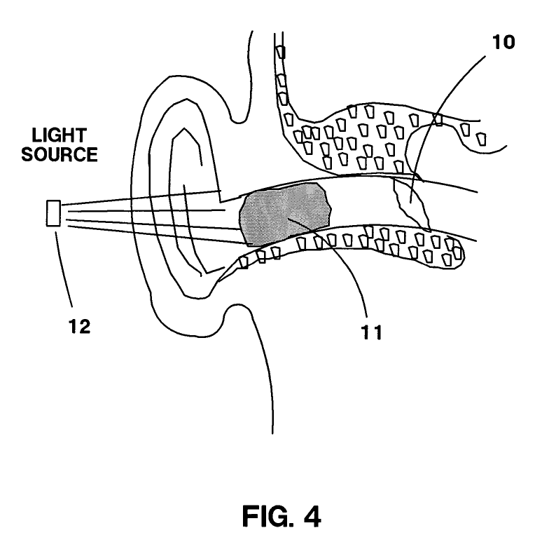

It is known in the dental arts to place flexible, uncured plastic into a tooth and then to cure it in-situ with a curing light. A similar technique can be used advantageously in the present invention. Thus, an alternate method of practicing the present invention is to form the plastic hearing device in the ear itself in-situ. This is shown schematically in FIG. 4. In this method, a translucent light-curable resin 11 or resin pre-form is put directly into the outer ear canal 9 exactly as if an impression were being taken. A light source 12 can then be directed into the resin while in the ear canal to partially harden it to the point where it can be removed for finishing without losing its shape. Final curing can take place outside the ear in the normal way (or can alternately take place entirely inside the ear). The translucent plug itself can act as a light pipe to carry the curing light energy to all portions of itself.

Light cured resins are somewhat exothermic during curing; however they are normally not harmfully so. An important material property of a resin used in this embodiment of the invention is that it not get hot enough to burn or cause discomfort to the patient during in-situ curing. Curing lamps using LED devices do not produce much unwanted infrared energy that would heat the ear tissue. A light pipe/pre-form device can be made extractable without too much difficulty. One method could be to use a Teflon™ surface and a small draft angle. The resin can be a soft and easily machine-able clear acrylic material, that can be removed with a preformed machining tool during a machining step. Using a proper light source and resin type, a safe in-situ curing can be made in order to capture the shape of the ear canal into the final device without having to use a mold. This causes a reduction in total fabrication time of over 30-45 minutes.

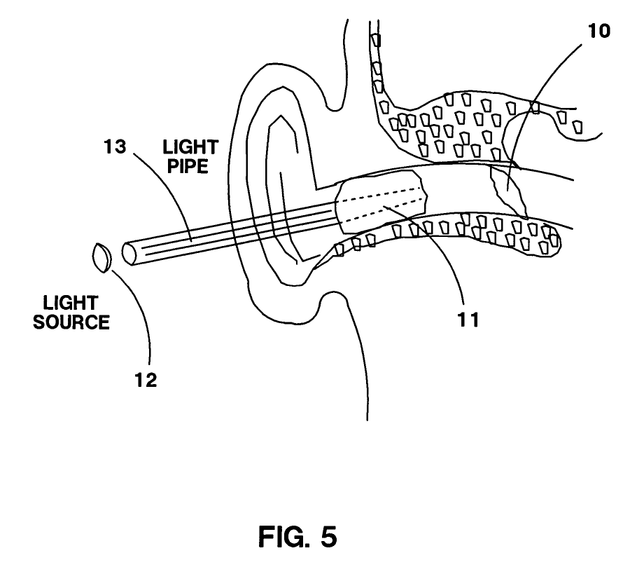

FIG. 5 shows schematically a similar process where a light pipe 13 extends into, and possibly through, the resin shell 11 in the ear canal 9. Here, a light source 12 causes light to enter the light pipe 13 and be channeled into the resin 11. The light pipe can extend into and even through the resin piece. This can be used to create a cavity in the resin piece for the electronics, speaker and microphone. The light pipe can also be made moldable or soluble in some solvent. In this case light pipe can be shaped or bent to better fit into the patient's ear. In the case of a soluble light pipe, a solvent can be used to dissolve the pipe rather than extracting it. The light pipe may also be composed of a light-transmitting, flexible elastomeric material to facilitate extraction after curing.

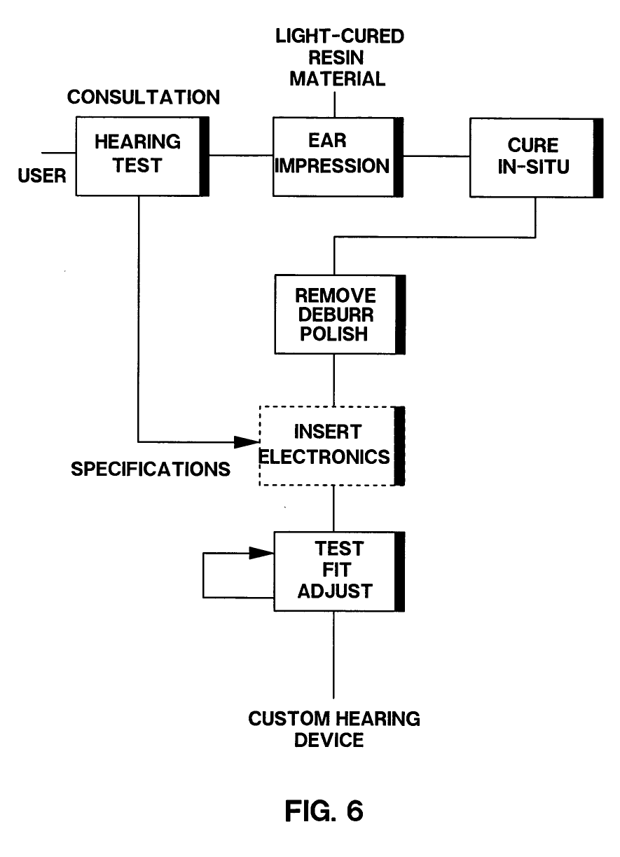

FIG. 6 shows a flow chart similar to that of FIG. 2 except that here, the cure takes place in-situ inside the ear canal. The other steps are similar to those of FIG. 2.

Several descriptions and illustrations have been presented to better aid in the understanding of the present invention. One skilled in the art will understand that numerous changes and variations are possible. Each of these many changes and variations is within the scope of the present invention.

I claim:

1. A method for efficiently supplying an ear-fitting hearing device comprising:
providing a particular location where a consumer can obtain a custom hearing device in a single visit, said particular location performing the following steps during said single visit:
taking a mechanical impression of said consumer's ear;
making a mold of said impression;
producing a hearing device from said mold;
fitting said hearing device to said consumer.

2. The method of claim 1 further comprising providing a hearing test for said consumer.

3. The method of claim 2 further comprising providing an electronic hearing aid component adjusted to requirements of said hearing test in said hearing device.

4. The method of claim 1 wherein said particular location is a mobile van.

5. The method of claim 1 wherein said hearing device is made from a light-curable resin.

6. The method of claim 1 wherein said mechanical impression is taken with rubbery dental impression material.

7. The method of claim 1 wherein said mold is translucent.

8. The method of claim 5 further comprising placing an insert into said light-curable resin before said resin is cured.

9. The method of claim 5 further comprising placing audio electronics into said light-curable resin before said resin is cured.

10. A system for supplying on-site manufacture for hearing devices comprising:
a vehicle equipped to evaluate a hearing device consumer and manufacture an on-site a hearing device for said consumer;
said vehicle containing a supply of dental rubber impression material, a supply of mold material, a supply of curable resin material, a de-burring tool, and a polishing tool, whereby an impression of said consumer's ear can be made with said dental rubber impression material, a mold can be made of said impression, a resin hearing device can be made from said mold and said resin hearing device can be de-burred with said de-burring tool and polished with said polishing tool for said consumer.

11. The system of claim 10 wherein said vehicle also contains a hearing test station.

12. The system of claim 10 wherein said vehicle also contains a supply of hearing aid electronic units for insertion of one into said resin hearing device.

13. The system of claim 10 wherein said vehicle also contains a hearing test station that creates hearing aid requirements for said consumer and wherein said vehicle also contains a supply of hearing aid electronic units for insertion of one into said resin hearing device, said one being adjusted before insertion according to said hearing aid requirements.

14. The system of claim 10 wherein said curable resin is a light-curable resin.

15. The system of claim 14 wherein said vehicle also contains a curing chamber to cure said light-curable resin.

16. The system of claim 14 wherein said mold material is translucent to allowing curing of said light-curable resin.

17. A method for efficiently supplying an ear-fitting hearing device comprising:
providing a particular location where a consumer can obtain a custom hearing device, said particular location performing the following steps:
placing a light-curable resin into said consumer's ear canal, said light-curable resin assuming a shape corresponding to that of said ear canal;
at least partially curing said light-curable resin in-situ in said ear canal using a light source that causes said resin to cure to form a resin piece;
removing said resin piece from said ear canal;
finishing said resin piece if necessary to produce a rigid hearing device;
fitting said rigid hearing device to said consumer.

18. The method of claim 17 further comprising a light pipe, said light pipe directing light from said light source into said resin piece.

19. The method of claim 18 wherein said light pipe is used to form a cavity in said resin piece.

20. The method of claim 17 wherein said steps are performed in a single visit to said particular location.
